(19) United States
(12) Patent Application Publication
(10) Pub. No.: US 2007/0279300 A1
(43) Pub. Date: Dec. 6, 2007

(54) Transmitting Antenna Arrangement For Emitting A Longwave Wake-Up Signal For An Id Transmitter In A Keyless Motor Vehicle Access System

(76) Inventors: Mirko Schindler, Velbert (DE); Andreas Van Den Boom, Essen (DE)

Correspondence Address: FAY SHARPE LLP, 1100 SUPERIOR AVENUE, SEVENTH FLOOR, CLEVELAND, OH, 44114, US

(21) Appl. No.: 11/632,982

(22) PCT Filed: May 4, 2005
(86) PCT No.: PCT/EP05/04870

§ 371 Date: Jan. 19, 2007

(30) Foreign Application Priority Data
Aug. 2, 2004 (DE) 10 2004 037 682.4

(51) Int. Cl. B60R 25/00

(52) U.S. Cl. 343/711

(57) ABSTRACT

A transmitting antenna arrangement for emitting a longwave wake-up signal for an ID transmitter in a keyless motor vehicle system includes an induction coil. The coil includes at least one winding and a core surrounded by the winding is arranged inside a component of the motor vehicle. The core is shaped as a flat strip and includes several layers placed on top of each other, containing a nano-crystalline or amorphous soft-magnetic metal alloy having a high permeability. The thickness of each metal layer is between 15 μm and 100 μm and the layers are placed on top of each other in such a way that the flow of current from one metal layer to another adjacent layer is made more difficult.

The invention relates to a transmitting antenna arrangement for emitting a longwave wake-up signal for an ID transmitter of a keyless motor vehicle access system with an induction coil disposed in the interior of a motor vehicle component with at least one coil and a core surrounded by the coil.

Such a transmitting antenna arrangement is known from, for instance, laid-open specification DE 102 36 957 A1. The publication describes a motor vehicle door handle with an electronic module integrated therein which includes a microcontroller connected to an antenna via an antenna driver. The antenna has a ferrite core, which is surrounded by a coil winding. Of disadvantage when using ferrite cores are the inaccuracies or large variations in the inductance produced, which are due to shrinkage of the ferrite during sintering and necessitate a subsequent adjustment of the antenna inductances thus produced. One solution resides, for instance, in constructing the antenna arrangement with two spaced ferrite core rods, whereby the trimming of the inductivity can be effected by altering the spacing of the end faces of the two ferrite core rods, which are arranged behind one another.

It is the object of the invention to provide economical transmitting antenna arrangements with reduced manufacturing tolerances.

This object is solved in accordance with the invention by a transmitting antenna arrangement with the features of Claim 1.

In the transmitter antenna arrangement in accordance with the invention, the core has the shape of a flat strip and consists of a plurality of layers, which are situated one above the other and extend over the entire length of the strip, wherein the layers include metal layers of a nanocrystalline or amorphous, soft magnetic metal alloy of high permeability, each of the metal layers having a thickness between 15 and 100 μm, preferably between 20 and 30 μm, and the metal layers being so arranged above one another that current flow from one metal layer to an adjacent layer is impeded. The use of the said material results in a core with the desired soft magnetic properties. The inductances of the coils produced on the basis of such cores may be adjusted during manufacture many times more accurately than the inductances of ferrite core coils, since the magnetic properties and dimensions of the cores are more precisely reproducible. The plurality of thin metal layers can be spaced apart by insulating layers or rest directly on one another, whereby the current flow between the layers in the latter case can be impeded by a special surface structure of the layers.

The cores manufactured from the thin metal alloy layers have a significantly higher mechanical flexibility (inter alia bending ability) by comparison with ferrite cores, which facilitates their installation in a motor vehicle component, particularly in a door handle. In addition to the small number of metal alloy layers, the cores have additional (thicker) insulating layers on the outer surfaces. The small number of thin metal alloy layers also enable the manufacture of a core and thus an antenna arrangement with a relatively low weight.

An amorphous cobalt alloy or alternatively a nanocrystalline alloy based on iron is preferably used as the thin metal alloy layer. A further advantage when using such layers to make cores for induction coils of antennae arrangements resides in the fact that the thin metal layers and the cores manufactured from them may be manufactured more economically than cores of ferrites. In a preferred embodiment, 5 to 20, preferably 6-10, metal layers are disposed above one another. This number results in an optimum in the desired magnetic properties and weight.

Advantageous and/or preferred embodiments of the invention are characterized in the dependent claims.

The invention will be described in more detail below with reference to a preferred exemplary embodiment illustrated in the drawings, which show as follows:

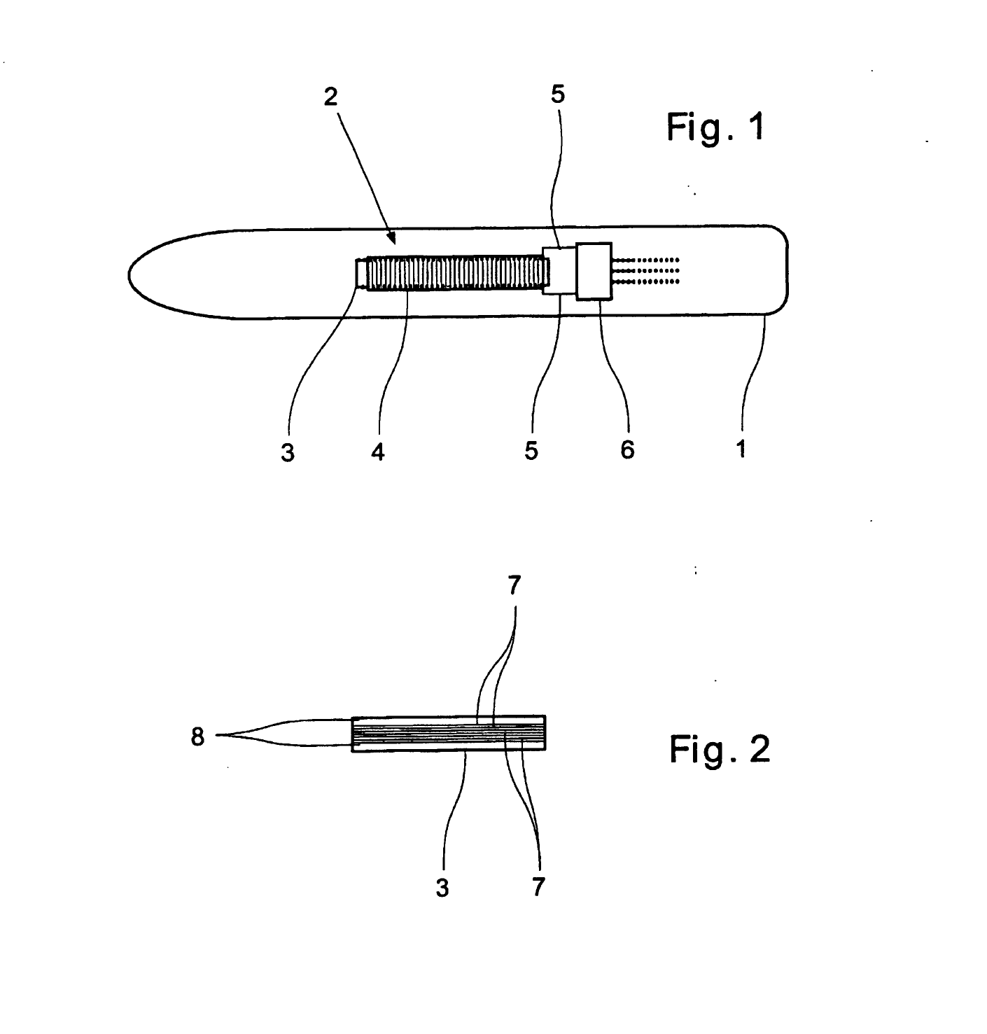

FIG. 1: a schematic plan view of a door handle with the transmitting antenna arrangement in accordance with the invention, and

FIG. 2: a schematic sectional view of the core used in the transmitting antenna arrangement.

The antenna arrangement in accordance with the invention for emitting a longwave wake-up signal for an ID transmitter of a keyless motor vehicle access system is typically disposed in the interior of a motor vehicle door handle. FIG. 1 is a schematic plan view of an outwardly facing side surface of a door handle 1. Disposed in the interior of the door handle is a series of electronic components, which commonly include a sensor for detecting grasping of the door handle, electronic control devices and an antenna arrangement 2 with an associated driver circuit. The antenna arrangement 2 includes a core 3 with a coil winding 4 arranged on it. The supply lines 5 of the coil 4 are connected to an antenna driver circuit 6. These elements are shown schematically, i.e. not true to scale, in FIG. 1. In the preferred induction coil 2 shown in FIG. 1, the winding 4 extends nearly over the entire length of the core 3. In other embodiments, only a section of the core could have a coil wound around it. The number of turns and the wire used (diameter and material) are determined in accordance with the desired electromagnetic properties, in particular the desired transmission carrier frequency and the operating range. These details are, however, of minor significance for the purposes of describing the present invention. The antenna arrangement preferably transmits on a carrier frequency of between 100 and 200 kHz, preferably about 125 kHz.

The core 3 has an elongate flat shape. FIG. 2 is a sectional view on a plane extending transverse to the longitudinal direction of the core. FIG. 2 is a schematic view, i.e. the ratio of the thickness to the breadth of the core and the proportions of the thicknesses of the layers do not necessarily correspond to the actual embodiment.

The core consists of a plurality of layers situated one above the other and extending over the entire length of the strip. These layers include metal layers 7. The metal layers consist of a nanocrystalline or amorphous soft magnetic metal alloy of high permeability and each have a thickness between 15 and 100 μm, preferably between 20 and 30 μm.

Arranged one above the other in the centre of the core are 5 to 20, preferably 6-10, metal layers 7, which are covered from above and below by a respective insulating layer 8. In the preferred embodiment, layers of a nanocrystalline cobalt alloy are used, which have a thickness of about 20 to 25 μm. For instance, the metal film sold under the mark VITROVAC from the company Vacuumschmelze GmbH can be used.

In the preferred embodiment, it is sufficient in order to achieve the desired magnetic characteristics to arrange only a few, preferably six, of these metal layers above one another. The metal layers arranged one above the other are electrically insulated from one another such that current flow between the layers is impeded. This can be achieved, for instance, by an insulating layer arranged between the layers. It is, however, also provided that the metal layers (films) be stacked abutting directly above one another, whereby the desired insulation is ensured as a result of special surface characteristics of the layers. The use of only a few layers results in the one hand in a relatively flexible, i.e. bendable, core and on the other hand in a further weight reduction with respect to conventional ferrite cores. The reduced weight of the induction coil results in a double weight reduction, if this induction coil is inserted into a motor vehicle door handle, as is provided in accordance with the invention, because the balancing mass situated in the interior of the door is also reduced in this case.

1-5. (canceled)

6. A transmitter antenna arrangement for emitting a longwave wake-up signal for an ID transmitter of a keyless motor vehicle access system with an induction coil disposed in an interior of a motor vehicle component, the induction coil having at least one winding and a core surrounded by the winding, the core having a shape of a flat strip and consisting of a plurality of layers which are situated one above the other and extend over the entire length of the strip, the layers comprising metal layers of a nanocrystalline or amorphous, soft magnetic metal alloy of high permeability, each of the metal layers having a thickness between 15 and 100 μm, and the metal layers being so arranged above one another that current flow from one metal layer to an adjacent layer is impeded.

7. The transmitter antenna arrangement of claim 6, comprising thin insulator layers arranged between adjacent metal layers.

8. The transmitter antenna arrangement of claim 6, wherein each of the metal layers has a thickness between 20 and 30 μm.

9. The transmitter antenna arrangement of claim 6, wherein 5 to 30 metal layers are arranged above one another.

10. The transmitter antenna arrangement of claim 8, wherein 6 to 10 metal layers are arranged above one another.

11. A transmitter antenna arrangement for emitting a longwave wake-up signal for an ID transmitter of a keyless motor vehicle access system with an induction coil disposed in an interior of a motor vehicle component, the induction coil including at least one winding and a core surrounded by the winding, the core including a flat strip which comprises a plurality of layers which are situated one above the other and extend over the entire length of the strip, the layers comprising metal layers of a nanocrystalline or amorphous, soft magnetic metal alloy of high permeability, each of the metal layers having a thickness between about 15 μm and 100 μm, wherein the metal layers are so arranged above one another that a current flow from one metal layer to an adjacent layer is impeded.

12. The transmitter antenna arrangement of claim 11, comprising thin insulator layers arranged between adjacent metal layers.

13. The transmitter antenna arrangement of claim 11, wherein each of the metal layers has a thickness between about 20 and 30 μm.

14. The transmitter antenna arrangement of claim 11, wherein between about 5 to 30 metal layers are arranged above one another.

15. The transmitter antenna arrangement of claim 13, wherein between about 6 to 10 metal layers are arranged above one another.
